(19) United States
(12) Patent Application Publication
(10) Pub. No.: US 2010/0275196 A1
(43) Pub. Date: Oct. 28, 2010

(54) System, method and computer program product for selecting and offering computational functionalities to a user

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 12/386,849

(22) Filed: Apr. 22, 2009

(51) Int. Cl. G06F 9/00; G06F 9/44; G06F 15/16

(52) U.S. Cl. 717/173; 713/2; 709/227

(57) ABSTRACT

A method system and computer product are provided to drive a process that includes powering up the computer; executing a basic input output system procedure; requesting information about and/or from a user; receiving information about and/or from the user; offering access to at least one computational functionality by the computer at least partly on the basis of the received information; and fulfilling the boot-up procedure. The offering of access to at least one computational functionality may include visually presenting an image to the user that when selected directs the computer to launch an associated software program and/or initiate a web service or a communications session. The computational functionality may include or provide accessibility to a web service via the Internet and/or establishing and maintaining a communications session.

### BACKGROUND OF THE INVENTION

1. Technical Field

The present invention generally relates to method and systems for providing and managing access to functionalities of a computer system. Specifically, the present invention relates to a method and system for selecting and offering access to computational functionalities.

2. Background Art

The increasing number of available software products and services, and goods and service available via software-enabled communication, can be overwhelming to a consumer. Many manufacturers of electronics communications enabled devices, e.g., cellular telephones and personal computers, offer third party software and provide offers of sale to goods and services as an aspect of the operation of these devices. In particular, several manufacturers of personal computers receive significant revenue from these third party vendors in return for bundling third party software and offers for sale of goods and services within the user experience of personal computers. The promotion of third party goods and services, to include software and web service purchases, by a device manufacturer after the initial out-of box-experience is another source of revenue to other device manufacturers, e.g., the sales of software, goods and services via the iPhone (TM) by Apple Computer, Inc. of Cupertino, Calif.

Yet the danger of information clutter can reduce the effectiveness of offers for sale via a computational device, wherein a purchaser or licensee of an electronic device can be annoyed by information overload in the boot process or out-of-box experience with a communications-enabled electronic device. This annoyance can lead to a reduction in user enjoyment of a purchased or leased device, and a negative effect in the incidence of sales of the offered third party software, goods and services. User frustration can be heightened when information provided by a device is perceived by the user to be inappropriate for consideration by the user. This annoyance and frustration can lead some users to disregard offers that might be of interest if offered in a less cluttered process by the device.

In view of the foregoing, there is a long-felt need to protect and strengthen the commercial value of offering software, goods and services to a user of a communications-enabled electronic device.

### SUMMARY OF THE INVENTION

This and other objects of the present invention are made obvious in light of this disclosure, wherein methods, systems and computer program product for enabling a computational device (hereinafter “computer”) to selectively offer access to computational functionalities at least partly on then basis of information regarding, or provided by, a user. According to one aspect of the method of the present invention, the information may include choices provided by the user, selections communicated by the user, descriptions of one or more qualities of the user, and/or indications of interest input by the user.

In another aspect of the method of the present invention, the computer is used to drive a process that includes powering up the computer; executing a basic input output system procedure; requesting information about and/or from a user; receiving information about and/or from the user; offering access to at least one computational functionality by the computer at least partly on the basis of the received information; and fulfilling the boot-up procedure. The offering of access to at least one computational functionality may include visually presenting an image to the user that when selected directs the computer to launch an associated software program and/or initiate a web service or a communications session.

In still another optional aspect of the method of the present invention a computer is provided that enables a user to direct the execution of one or more aspects of the method of the present invention.

In still another optional aspect of the method of the present invention a computer-readable medium is provided that when executed by a computer may cause the computer to perform one or more aspects of the method of the present invention.

The foregoing and other objects, features and advantages will be apparent from the following description of aspects of the present invention as illustrated in the accompanying drawings.

### Incorporation by Reference

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

U.S. Pat. No. 7,278,093 (Jablonski, et al.; issued Oct. 2, 2007) titled “Custom computer wallpaper and marketing system and method”; U.S. Pat. No. 7,206,929 (Rhoades D. B.; issued on Apr. 17, 2007) titled “Method for customizing a computer system by using stored configuration parameters in a configurism mechanism” and U.S. Pat. No. 7,225,325 (Rhoades, D. B.; issued on May 29, 2007) titled “Customizing a computer system by using stored configuration parameters in a configuration mechanism”; United States Patent Application Publication Ser. No. 20070156836 (Kelso, et al.; published Jul. 5, 2007) titled “System and method for electronic chat identity validation”; United States Patent Application Publication Ser. No. 20080077873 (Peterson, Harold Lee; published Mar. 27, 2008) titled “Apparatus, method and computer-readable medium for organizing the display of visual icons associated with information technology processes”; and U.S. patent application Ser. No. 09/423,025 (Peterson, H. L., et al.; filed on Oct. 28, 1999) titled “Digital content vending, delivery and maintenance system” are each incorporated herein by reference in their entirety and for all purposes.

All publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 is a flowchart of a boot-up process of a computer-implemented process wherein a first aspect of the method of the present invention is practiced by a computer;

FIG. 2 is a flowchart of a computer-implemented process wherein a second aspect of the method of the present invention is practiced by the computer of FIG. 1 in communication with a server;

FIG. 3 is an illustration of a visual presentation of a first window by the computer of FIGS. 1 and 2;

FIG. 4 is a flowchart of a computer-implemented process the computer of FIGS. 1, 2 and 3 accepts information received in relation to the first window of FIG. 3;

FIG. 5 is an illustration of a presentation of a new user window by the computer of FIGS. 1 through 4;

FIG. 6 is a flowchart of a computer-implemented process the computer of FIGS. 1 through 5 accepts information received in relation to the new user window of FIG. 3;

FIG. 7 is an illustration of a presentation of a profile builder window by the computer of FIGS. 1 through 6;

FIG. 8 is an illustration of a presentation of an interests window by the computer of FIGS. 1 through 7;

FIG. 9 is an illustration of a presentation of a personality window by the computer of FIGS. 1 through 8;

FIG. 10 is a schematic of a presentation a user account table maintained by the computer of FIGS. 1 through 9;

FIG. 11 is a schematic of a presentation a software registry maintained by the computer of FIGS. 1 through 10;

FIG. 12 is a schematic diagram illustrating certain binary data stored within an exemplary first user personality data field and a first user interests data field of a first user account table of FIG. 10;

FIG. 13 is a schematic diagram illustrating a plurality of software match binary data stored within the exemplary first personality matching data and the first interests matching data field of the exemplary first software record of FIG. 11;

FIG. 14 is a flowchart of a computer implemented process wherein an even additional aspect of the method of the present invention is practiced wherein icon data is selected for rendering by the computer of FIGS. 1 through 13;

FIG. 15 is a flowchart of a computer-implemented process wherein a software program may be deleted from the computer of FIGS. 1 through 14;

FIG. 16 is an illustration of the start-up desktop image as rendered by the computer of FIGS. 1 through 15 in part from the plurality of application icon display data of the software records of the software registry;

FIG. 17 is a schematic diagram of the computer of FIGS. 1 through 16;

FIG. 18 is a schematic diagram of the system software of the computer of FIGS. 1 through 17;

FIG. 19 is a schematic diagram of the electronics communications network of FIGS. 2 and 17; and

FIG. 20 is a flowchart of a computer implemented process wherein a still alternate aspect of the method of the present invention is practiced when the computer of FIGS. 1, 16, 17 and 18 is offline and/or not in communication with the electronic communications network and/or the remote server of FIG. 18.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Embodiments of method for allocating memory during pre-boot in a manner that facilitates efficient hand-off to an operation system and computer apparatus for implementing the method are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one aspect” or “an aspect” means that a particular feature, structure, or characteristic described in connection with the aspect is included in at least one process or hardware configuration that is in accordance with the method of the present invention. Thus, the appearances of the phrases “in one aspect” or “in an aspect” in various places throughout this specification are not necessarily all referring to the same instantiation of the method of the present invention. Furthermore, each particular aspect of the method of the present invention, may be included in singularity or in combination in any suitable manner in one or more systems or methods.

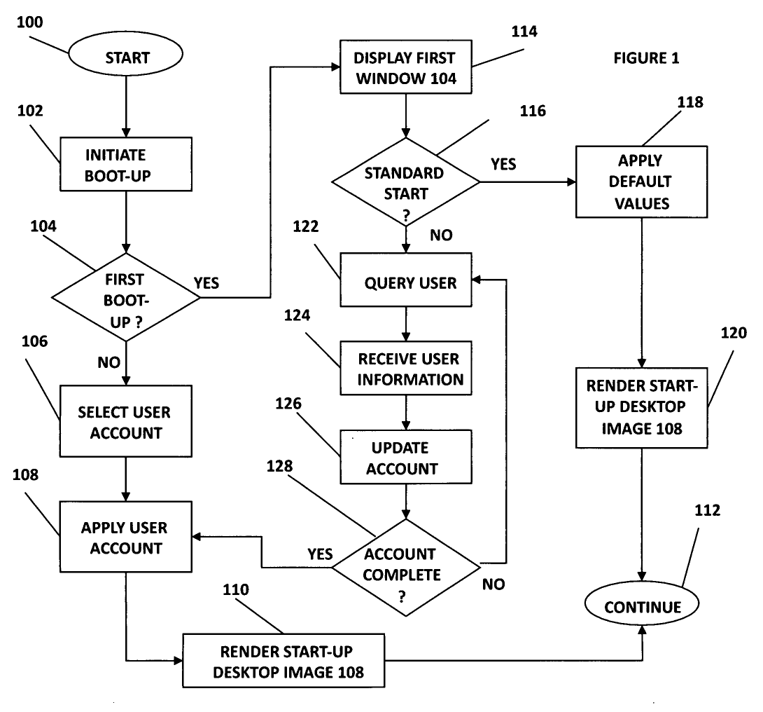

Referring now generally to the Figures and particularly to FIG. 1, FIG. 1 is a flowchart of a computer implemented process wherein a first aspect of the method of the present invention is practiced. In step 100 a computer 100 receives a boot-up command and electrical power is provided to the computer 100. In step 102 a boot-up process of the computer 100. In step 104 the computer 100 determines whether the current boot-up process is part of a first boot-up process of an out-of-the-box experience of a new user of the computer 100. When the computer 100 determines in step 104 that the computer 100 is not performing a first boot-up, the computer 100 proceeds form step 104 to step 106 and to select an exemplary user account record 112.A (or “user account” 112.A) from a plurality of existing user accounts 112.A-112.N and apply the selected user account records 112.A-112.N (or “user accounts” 112.A-112.N) in step 108 to render a start-up desktop image 108 in step 110. The computer 100 proceeds from step 110 to step 112 and to perform additional computational processes in step 112.

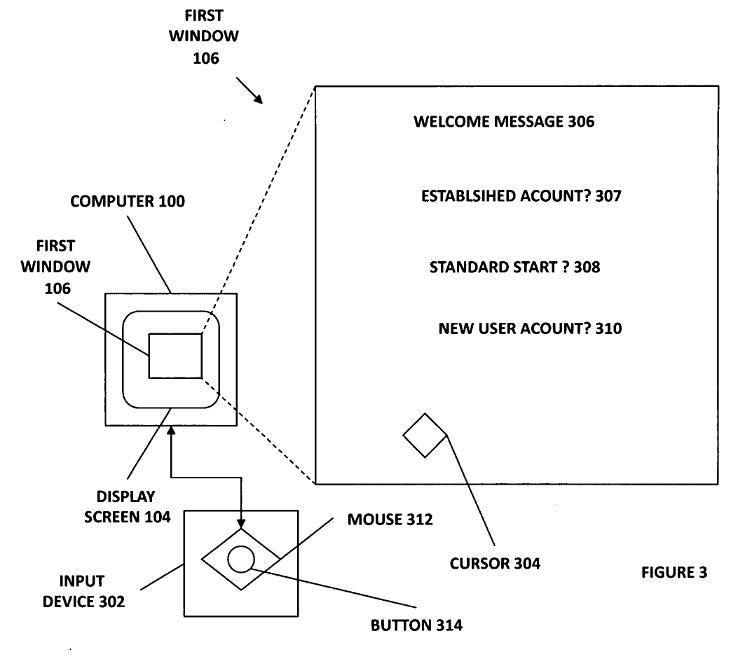

When the computer 100 determines in step 104 that the current boot-up process is a first boot-up of an out-of-the box experience provided by the computer 100, the computer 100 proceeds from step 104 to step 114 and to cause a display screen 104 to display a first window 106 of FIG. 3. The computer 100 determines in step 116 whether a user directs the computer 100 to apply default values to continue the boot-up process or to form a user account 112.A-112.N to direct the boot-up process. When the computer 100 determines in step 116 that the user directs the computer 100 to apply default values to continue the boot-up process, the computer 100 proceeds to step 118 and the apply the default values in step 118, and to render a start-up desktop image 108. In the standard rendering process of the start-up desktop image 108 a predesignated plurality of application icon display data 110.A-110.Z of the application icons 110.A-110.Z are visually displayed by the display screen 102 of the computer 100.

When the computer 100 determines in step 116 that the user directs the computer 100 to form a new user account record 112.A-112.N (or “user account” 112.A-112.N), the computer 100 proceeds to step 122 to query the user for preferences and user characteristics that are applied by the computer 100 to populate a new user account 112.A-112.N. In step 124 the computer 100 receives information provided by the user and in step 126 the computer 100 updates the new user account 112.A-112.N. It is that the information provided by the user may be provided as user selections from visually displayed menus 106, 112, 114, 116 and 118 and by alphanumeric data input. When the computer 100 determines in step 128 that the user has directed the computer 100 to end the account information loop of steps 122 through 128, the computer 100 proceeds from step 128 to step 108. The instant user account 112.A-112.N populated in steps 122 through 128 is then applied in step 108, wherein the computer 100 selects one or more application icon display data 110.A-110.Z from the plurality of application icon display data 110.A-110.Z at least partly on the basis of the information provided by the instant user account 112.A-112.N, and the computer visually displays the selected application icon display data 110.A-110.N on the display screen 104 in step 110.

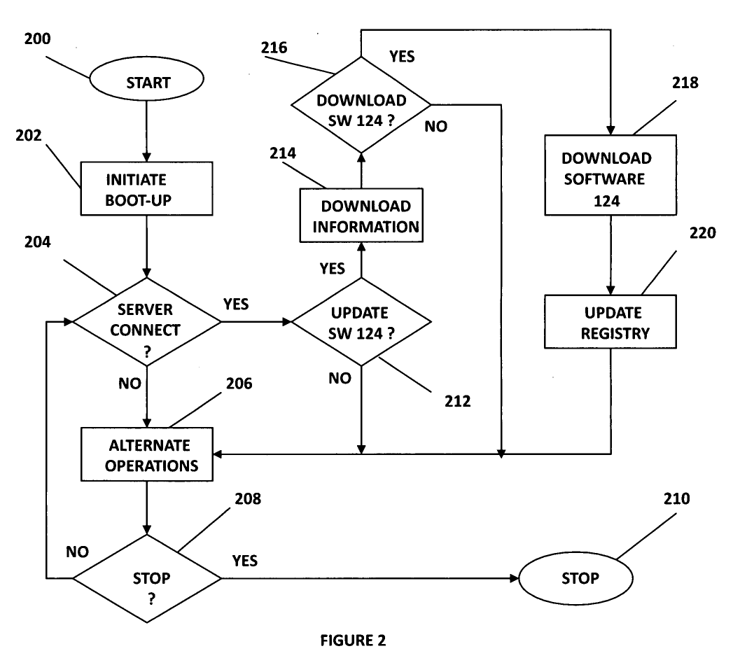

Referring now generally to the Figures and particularly to FIG. 2, FIG. 2 is a flowchart of a computer implemented process wherein a second aspect of the method of the present invention is practiced. In step 200 the computer 100 receives a boot-up command and electrical power is provided to the computer 100. In step 202 a boot-up process of the computer 100 is initiated. In step 204 the computer 100 attempts to initiate a communications session with a remote server 120 via an electronics communications network 122. When the computer 100 determines that a communication session with the remote server 120 is not established in step 204, the computer 100 proceeds from step 204 to step 206 and to perform alternate computational processes. The computer 100 proceeds from step 206 to step 208 and to determine whether to continue computational operations. When the computer 100 determines in step 208 to continue computational operations, the computer 100 returns to step 204 and to initiate a communications session with the remote server 120. When the computer 100 determines in step 208 to not continue computational operations, the computer 100 proceeds to step 210 and to power down.

When the computer 100 determines that a communication session with the remote server 120 is established in step 204, the computer 100 proceeds from step 204 to step 212 and to determine whether the server 120 has an information update to provide to the computer 100. When the computer 100 determines in step 212 that the server 120 does not have an information update to provide to the computer 100, the computer 100 proceeds from step 212 to step 206. Alternatively, when the computer 100 determines in step 212 that the server 120 does have an information update to provide to the computer 100, the computer 100 proceeds from step 212 to step 214 and to download information from the server 120. The computer 100 proceeds from step 214 to step 216 and to determine whether the server 120 has an application software update or new software to provide to the computer 100. When the computer 100 determines in step 216 that the server 120 does not have an application software update or new software to download to the computer 100, the computer 100 proceeds to step 206.

Alternatively, when the computer 100 determines in step 216 that the server 120 has an application software update or new software to download to the computer 100, the computer 100 proceeds to step 218 to download application software, software encoded instructions, information and/or software updates 124 and update a software registry 126 of the computer 100. The software registry 126 contains a plurality of software records 128.A-128.Z, wherein each software record 26.A-26.Z contains information relating to an individual software program 130.A-130.Z. An exemplary first software application 130.A when executed by the computer 100 enables the computer to access a web service in coordination with the server 120.

Referring now generally to the Figures and particularly to FIG. 3, FIG. 3 is an illustration of a presentation by the computer 100 of an alternate visual aspect of the method of the present invention. The computer 100 includes an input module that includes an input device, e.g., a computer mouse, a digital keypad or keyboard, and/or a trackball module that that the user uses to control the position of a cursor 304 within the display screen 104. The first window 106 includes an explanatory welcome message 306 that explains that by creating a user account 112.A-102.Z the user may provide information useful to direct the computer 10 to provide a better boot-up experience, and/or a better out-of-the box experience, wherein the computer may both (a.) avoid presenting information to the user in the initial start-up desktop image 108 that is unlikely to be of interest to the user; and (b.) select and display information that is more likely to be of interest to the user in the initial start-up desktop image 108. The welcome message 306 further explains that (a.) selecting the new user account option 308 will enable the computer to create a user account 112.A-112.N by interaction with the user; and (b.) selecting the standard start 310 choice will direct the computer 100 to present a standard listing of information to the user.

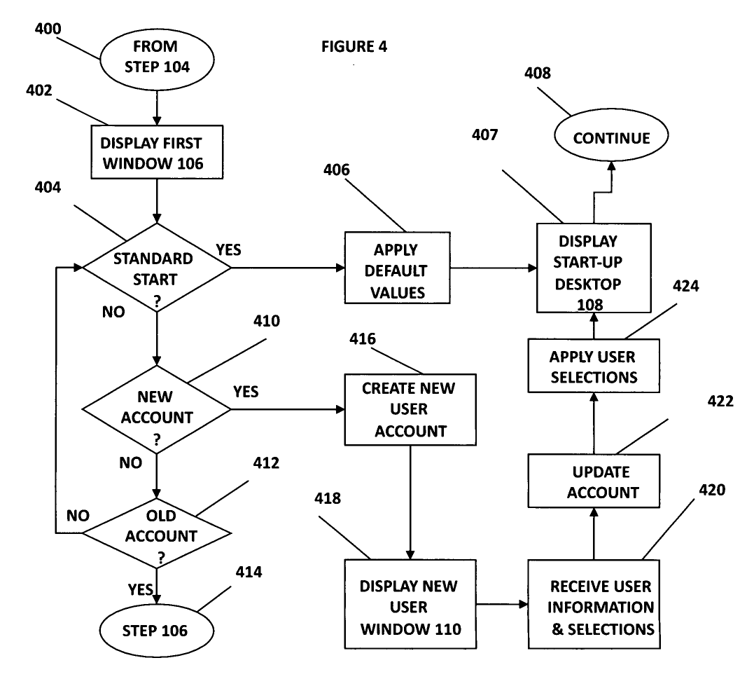

Referring now generally to the. Figures and particularly to FIG. 4, FIG. 4 is a flowchart of a computer implemented process wherein a still alternate aspect of the method of the present invention is practiced. The computer 100 proceeds from step 104 of the process of FIG. 1 to display the first window 106 in the display screen 102 in step 402. The computer determines in step 404 whether the user has chosen the standard start option 308 by means of the input device 302. In one exemplary configuration of the computer 100, the input module 302 comprises a computer mouse 312 and the user positions the cursor 304 over the displayed text of the standard start option 310 as displayed on the display screen 104, and the user additionally engages a selection button 314 of the computer mouse 312. The engagement of the selection button 314 of the computer mouse 312 thereby issues a command to the computer 100 to proceed from step 404 to step 406 and to apply default values to the boot-up process initiated in step 102 of the process of FIG. 1. The computer 100 proceeds from step 406 to step 407 and to display the start-up desktop image 108 on the display screen 102. The computer 100 then proceeds from step 407 to step 408 to perform additional computational processes.

Alternatively, the computer determines in step 410 whether the user has chosen the new account start 310 by means of the input device 302. When a selection of neither the standard start 308 is determined in step 404, nor a selection of the new account start 310 is determined in step 410, the computer 100 proceeds on to step 412. Computer 100 determines in step 412 whether the user has selected an established, I.e. an “old account”, from the first display window 106. When the computer 100 determines in step 412 that the user has selected an established user account from the display first window 106, the computer 106 proceeds from step 412 to step 414 and to execute step 106. When the computer 100 determines in step 412 that the user has not selected an established user account from the display first window 106, the computer 100 proceeds from step 412 to step 404.

When the computer 100 determines in step 410 whether the user has chosen the new account start 310 by means of the input device 302, the computer 100 proceeds to step 416 and to create a new user account 112.A-112.N, and to display the new user window 112 in step 418 via the display screen 104. The computer 100 receives information and menu item selections from the computer in step 420, and in step 422 the computer 100 updates and populates the user account 112.A-112.N created in step 416 with the selections and information received the user. The computer 100 applies the instant user account 112.A-112.N in step 424 in the boot-up process initiated in step 102, wherein the information and menu item selections received in step 420 are applied. The computer 100 proceeds from step 424 to step 407 and to display a start-up desktop image 108 on the display screen 102. The computer 100 then proceeds from step 407 to step 408 to perform additional computational processes.

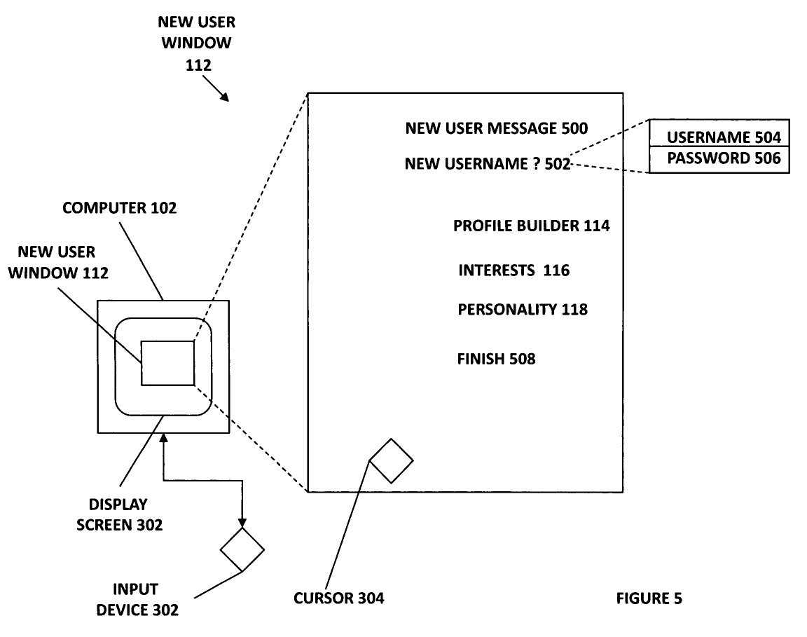

Referring now generally to the Figures and particularly to FIG. 5, FIG. 5 is an illustration of a presentation by the computer 100 of an alternate visual aspect of the method of the present invention. The new user window 112 includes a new user message 500 that explains the function of the new user window 112 in enabling the user to populate a new user account 112.A-112.N. A new username option 502 allows the user to input alphanumeric data from the input device 302 to define a username 504 and a password 506. The new username 504 and the password 506 will be stored in, or associated with, the new user account 112.A-112.N.

The new user window 112 further contains click through options to the profile builder window 114, the interests menu 118, the personality menu 118, and a finish command 508. A selection of the finish command by the user directs the computer 100 to cease populating the new account 112.A-112.N and proceed with the boot-up process.

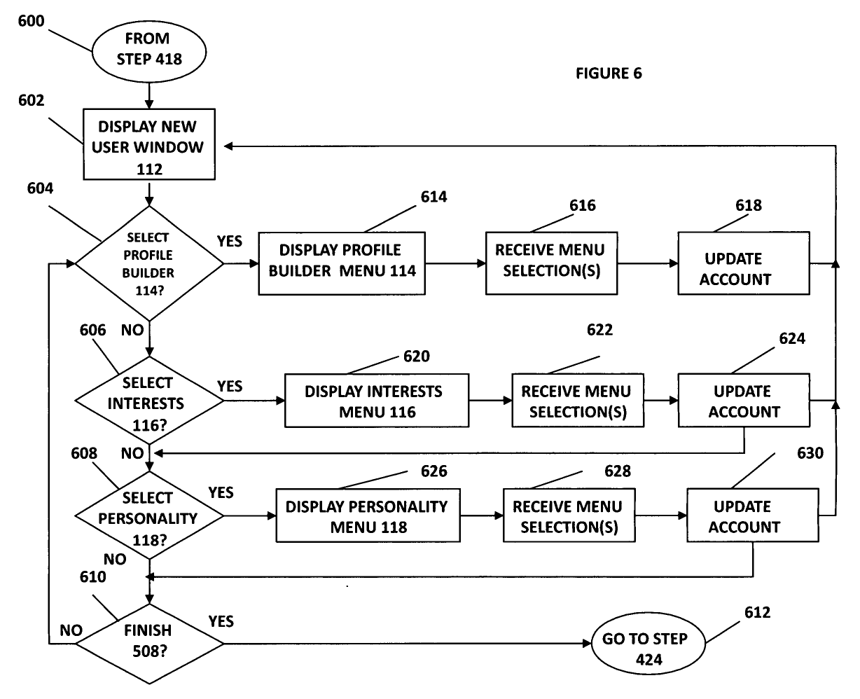

Referring now generally to the Figures and particularly to FIG. 6, FIG. 6 is a flowchart of a computer implemented process wherein a yet other aspect of the method of the present invention is practiced. The computer 100 proceeds from step 418 of the process of FIG. 4 to step 602 and displays the new user window in step 602 by means of the display screen 302. The computer determines (a.) in step 604 whether the user has selected the profile builder window 114; (b) in step 606 whether the user has selected the interests window 116; (c.) in step 608 whether the user has selected the personality menu 118; and (d.) in step 610 whether the user has selected the finish command 508. When the computer 100 detects a user selection of the finish command 508, the computer 100 proceeds on to step 612 and to execute step 424 of the process of FIG. 4.

When the computer 100 determines in step 604 that the user has selected the profile builder window 114, the computer 100 proceeds from step 604 to step 616 to display the profile builder window 114; then to step 616 to receive menu selections and information from the user; and then to step 618 to update the exemplary new user account 112.A. The computer 100 proceeds from step 618 back to execute step 602 and to again display the new user window in step 602 by means of the display screen 302.

When the computer 100 determines in step 606 that the user has selected the interests window 116, the computer 100 proceeds from step 606 to step 620 to display the interests window 116; then to step 622 to receive menu selections and information from the user; and ten to step 624 to update the exemplary new user account 112.A with the menu selections and information received in step 622. The computer 100 proceeds from step 624 back to execute step 602 and to again display the new user window in step 602 by means of the display screen 302.

When the computer 100 determines in step 608 that the user has selected the personality menu 118, the computer 100 proceeds from step 608 to step 626 to display the personality menu 118; then to step 628 to receive menu selections and information from the user; and ten to step 630 to update the exemplary new user account 112.A with the menu selections and information received in step 626. The computer 100 proceeds from step 6130 back to execute step 602 and to again display the new user window in step 602 by means of the display screen 302.

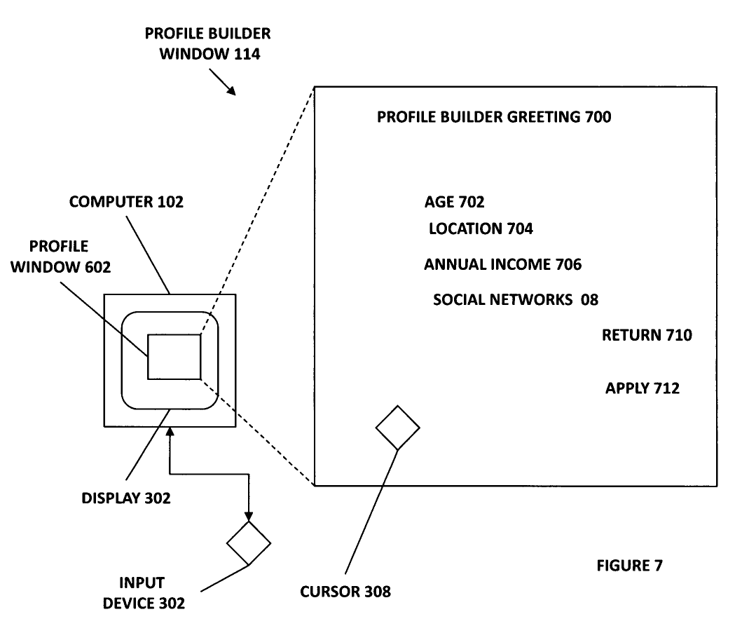

Referring now generally to the Figures and particularly to FIG. 7, FIG. 7 is an illustration of a presentation by the computer 100 of an additional visual aspect of the method of the present invention. The profile builder window 114 includes a profile builder greeting 700 that explains to the user the function of the profile builder window 114 in gathering information that enables the computer 100 to personalize the start-up desktop image 108. An age option 702 enables the user to input an age datum. A location option 704 enables the user to input a location datum. An annual income option 706 enables the user to input an annual income datum. A social networks option enables the user to input information related to a mediated electronic social network service, e.g., TWITTER (TM), FACEBOOK (TM) or MYSPACE (TM) social network service.

A return option 710 allows the user to direct the computer 100 to return to the new user window 112. An apply option 712 enables the user to direct the computer 100 to apply the exemplary new user account 112.A to generate the desktop start-up image 108.

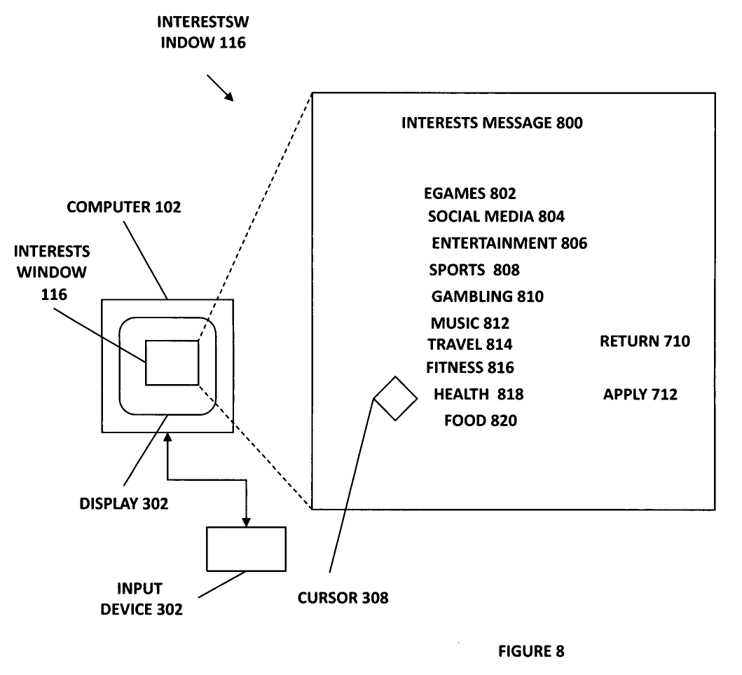

Referring now generally to the Figures and particularly to FIG. 8, FIG. 8 is an illustration of a presentation by the computer 100 of an even other alternate visual aspect of the method of the present invention. The interests window 116 includes a an interests message 800 that explains to the user the function of the interests window 116 in gathering information that enables the computer 100 to personalize the start-up desktop image 108.

An egames interests descriptor 802 enables the user to direct the computer 100 to note within the exemplary user account 102 an interests in electronic games by the user; a social media interests descriptor 804 enables the enables the user to direct the computer 100 to note within the exemplary user account 112.A an interest in social media by the user; an entertainment interests descriptor 806 enables the user to direct the computer 100 to note within the exemplary user account 112.A an interest in entertainment programs by the user; a sports interests descriptor 808 enables the user to direct the computer 100 to note within the exemplary user account 112.A an interest in sports by the user; a gambling interests descriptor 810 enables the user to direct the computer 100 to note within the exemplary user account 112.A an interest in gambling by the user; a music interests descriptor 812 enables the user to direct the computer 100 to note within the exemplary user account 112.A an interest in music by the user; a travel interests descriptor 814 enables the user to direct the computer 100 to note within the exemplary user account 112.A an interest in travel by the user; a fitness interests descriptor 816 enables the user to direct the computer 100 to note within the exemplary user account 112.A an interest in physical fitness by the user; a health interests descriptor 820 enables the user to direct the computer 100 to note within the exemplary user account 112.A an interest in personal health by the user; and a food interests descriptor 820 enables the user to direct the computer 100 to note within the exemplary user account 112.A an interest in food by the user.

Additional interests that the user may direct the computer 100 to note within the exemplary user account 112.A an interest by the user include technology, fashion, sports, health, and software.

The return option 710 allows the user to direct the computer 100 to return to the new user window 112; and the apply option 712 enables the user to direct the computer 100 to apply the exemplary new user account 112.A to generate the start-up image 108.

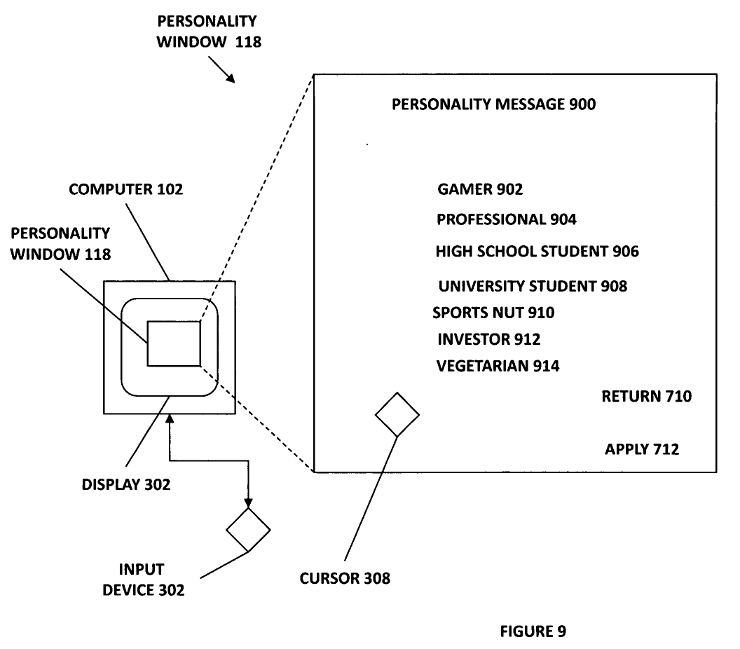

Referring now generally to the Figures and particularly to FIG. 9, FIG. 9 is an illustration of a presentation by the computer 100 of a yet other alternate visual aspect of the method of the present invention. The personality window 118 includes a personality message 900 that explains to the user the function of the personality descriptors 902-914, or “options” 902-914.

A gamer personality descriptor 902 enables the user to direct the computer 100 to note within the exemplary user account 112.A an interest in electronic games by the user; a professional personality descriptor 904 enables the user to direct the computer 100 to note within the exemplary user account 112.A a self-identification of the user as a professional; a high school student personality descriptor 906 enables the user to direct the computer 100 to note within the exemplary user account 112.A a self-identification of the user as a high school student; a University student personality descriptor 908 enables the user to direct the computer 100 to note within the exemplary user account 112.A a self-identification of the user as a University student; a sports nut personality descriptor 910 enables the user to direct the computer 100 to note within the exemplary user account 112.A a self-identification of the user as a sports enthusiast; an investor personality descriptor 912 enables the user to direct the computer 100 to note within the exemplary user account 112.A an interest in financial topics; and a vegetarian personality descriptor 914 enables the user to direct the computer 100 to note within the exemplary user account 112.A a self-identification of the user as a vegetarian.

Additional personality descriptors may enable the user to self-identify to the computer 100 as a small business manager, health care worker, technologist, child, shopper, retiree, senior and/or health care worker.

The return option 710 allows the user to direct the computer 100 to return to the new user window 112; and the apply option 712 enables the user to direct the computer 100 to apply the exemplary new user account 112.A to generate the desktop start-up image 108.

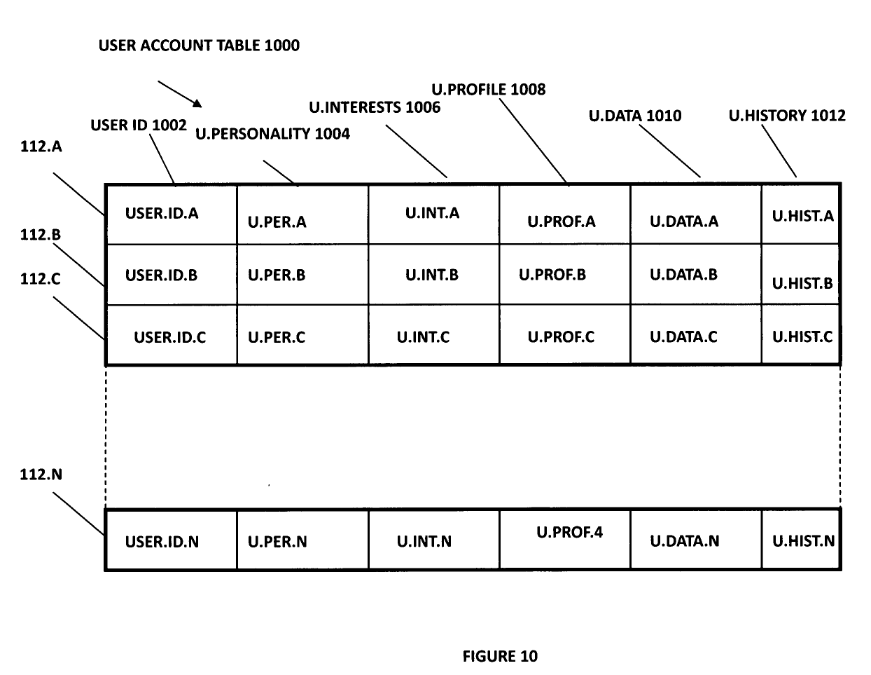

Referring now generally to the Figures and particularly to FIG. 10, FIG. 10 is a schematic of a presentation a user account table 1000 maintained by the computer 100. The user account table 1000 stores a plurality of user accounts 112.A-112.N. Each user account 112.A-112.N contains information that directs the computer 100 in rendering the boot-up desktop 108 of the computer 100. A default account record 112.N includes information accessed by the computer 100 in rendering the start-up desktop 108 when the user directs the computer 100 to apply default values in rendering the start-up desktop 108. A user identification data field 1002 of each user account 112.A-112.N optionally includes an identifier of a user, a user name and/or a password. Each user account 112.A-112.N includes a plurality of data fields of information associated with a user identified in the user identification data field 1002 of the user account 112.A-112.N comprising the individual user identification field.

A personality identification data field 1004 of each user account 112.A-112.N optionally includes information and selections U.PER.A-U.PER.N made by a user in interaction with the personality window 114. An interests identification data field 1006 of each user account 112.A-112.N optionally includes information and selections U.INT.A-U.INT.N made by a user in interaction with the interests window 116. A profile data field 1008 of each user account 112.A-112.N optionally includes information and selections U.PROF.A-U.PROF.N made by a user in interaction with the profile data builder window 118.

A user data field 1010 of each user account 112.A-112.N optionally includes information related to the user identified in the user identification data field 1002 of a same user account 111.A-112.N, and may include financial account information, language preferences and other user related data. A user history data field 1012 of each user account 112.A-112.N optionally includes information related to a history of interaction of user, as identified in the user identification data field 1002 of a same user account 112.A-112.N, with the computer 100, the server 120 and/or the electronics communications network 122.

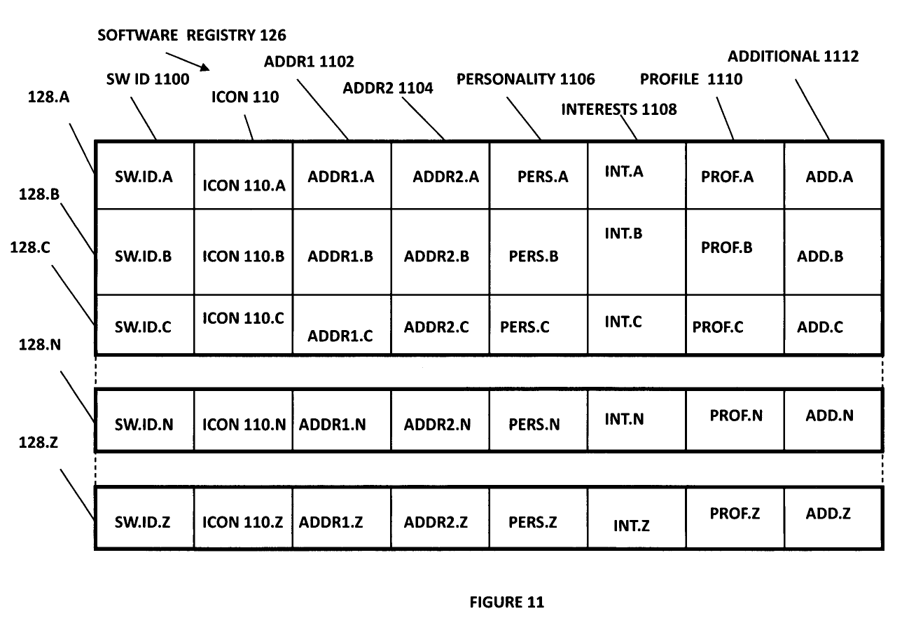

Referring now generally to the Figures and particularly to FIG. 11, FIG. 11 is a schematic of a presentation the software registry 126 maintained by the computer 100. As mentioned previously, the software registry 126 includes the plurality of software records 128.A-128.Z, wherein each software record 128.A-128.Z includes information related to an individual software program 128.A-128.Z identified in a software identification data field 1100 of the specific software record 128.A-128.Z. One or more individual software programs 128.A-128.Z may be stored in the computer 100, the server 120, the network 122, and/or a computer program product 132. The icon software 110.A-110.Z associated with the software program 128.A-128.Z identified in the software identification data field 1100, e.g., SW.ID.A-SW.ID.Z, of a same software record 128.A-128.Z. A first address data field 1102 identifies a first memory address ADDR1.A-ADDR1.Z within the computer 100, the server 120, the network 122, or the computer program product 132 at where at least a portion of the associated software program 130.A-130.Z is addressable. A second optional address data field 1104 identifies a second memory address ADDR2.A-ADDR2.Z within the computer 100, the server 120, the network 122, or the computer program product 132 at where at least a portion of the associated software program 130.A-130.Z is addressable. A registry personality data field 1106 includes personality matching data field PERS.A-PERS.Z, each personality matching data field PERS.A-PERS.Z for use by the computer 100 in separately evaluating an individual software program 130.A-130.Z for reference, by display of an associated application icon display data 110.A-110.Z, in the start-up desktop image 108. An interests data field 1108 includes interests matching data INT.A-INT.Z, each interests matching data INT.A-INT.Z for use by the computer 100 in separately evaluating an individual software program 130.A-130.Z for reference, by display of an associated application icon display data 110.A-110.Z, in the start-up desktop image 108. A profile data field 1110 includes profile matching data field PROF.A-PROF.Z, each profile matching data field PROF.A-PROF.Z for use by the computer 100 in separately evaluating an individual software program 130.A-130.Z for reference, by display of an associated application icon display data 110.A-110.Z, in the start-up desktop image 108.

An additional registry data field 1112 additional data ADD.A-ADD.Z, each additional data ADD.A-ADD.Z for use by the computer 100 in separately evaluating an individual software program 130.A-130.Z for reference, by display of an associated application icon display data 110.A-110.Z, in the start-up desktop image 108. For example, the additional registry data field 112 may contain a display instruction directing the computer to always display a particular application icon display data 110.A-110.Z in the start-up desktop image 108, or a maintenance instruction prohibiting the computer 100 from deleting an associated software program 130.A-130.Z from the computer 100.

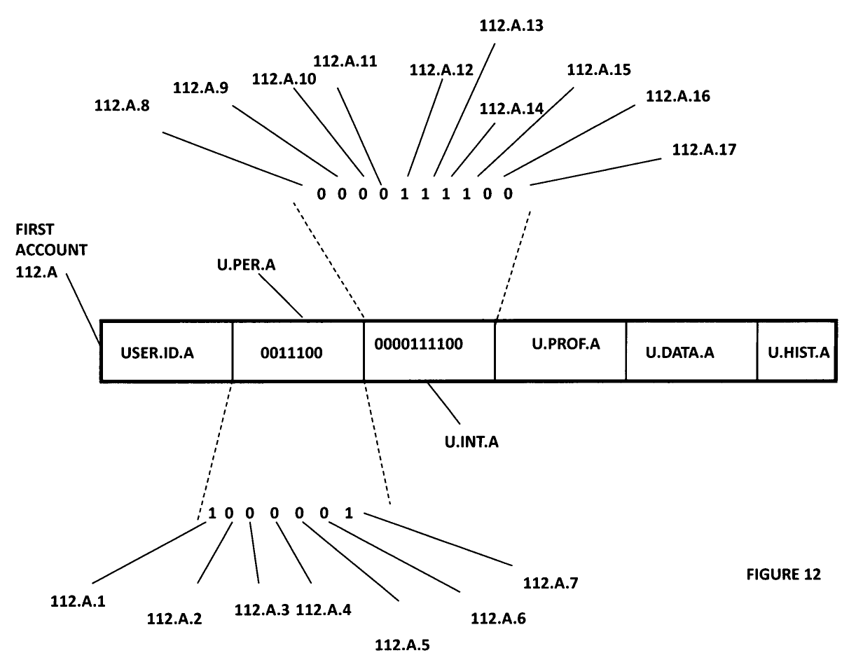

Referring now generally to the Figures and particularly to FIG. 12, FIG. 12 is a schematic diagram illustrating certain binary data 112.A.1-112.A.17 stored within the exemplary first user personality data field U.PER.A and the first user interests data field U.INT.A of the first user account 112.A. Each of a plurality of seven personality binary bits 112.A.1-112.A.7 of the first user personality data field U.PER.A indicate whether the user identified in the first user identification field USER.ID.A has self-identified as having a particular personality aspect identified by a named personality descriptor 902-914. In the exemplary application of a user account 112.A-112.N of step 424 of the process of FIG. 4, (a.) a zero value 0 indicates that the user associated with a particular user account 112.A-112.N has not self-identified with the personality descriptor 902-914 associated with the zero value 0; and (b.) a one value 1 indicates that the user associated with a particular user account 112.A-112.N has self-identified with the personality descriptor 902-914 associated with the one value 1. For example, the first personality binary bit 112A.1 relates to the first personality descriptor gamer 902, and a one value 1 of the first personality binary bit 112A.1 would indicate that the user identified in the first user identification field USER.ID.A has self-identified as a gamer, whereas a zero value 0 of the first personality binary bit 112A.1 would indicate that the user identified in the first user identification field USER.ID.A has not self-identified as a gamer.

Furthermore, a user self-identification with the professional personality descriptor 904 is indicated by a one value 1 of the second binary bit 112.A.2; a user self-identification with the high school student personality descriptor 906 is indicated by a one value 1 of the third binary bit 112.A.3; a user self-identification with the University student personality descriptor 908 is indicated by a one value 1 of the fourth binary bit 112.A.4; a user self-identification with the sports nut personality descriptor 910 is indicated by a one value 1 of the fifth binary bit 112.A.5; a user self-identification with the investor personality descriptor 912 is indicated by a one value 1 of the sixth binary bit 112.A.6; and a user self-identification with the vegetarian personality descriptor 914 is indicated by a one value 1 of the seventh binary bit 112.A.7.

Alternatively, a lack of a user self-identification with the professional personality descriptor 904 is indicated by a zero value 0 of the second binary bit 112.A.2; a lack of a user self-identification with the high school student personality descriptor 906 is indicated by a zero value 0 of the third binary bit 112.A.3; a lack of a user self-identification with the University student personality descriptor 908 is indicated by a zero value 0 of the fourth binary bit 112.A.4; a lack of a user self-identification with the sports nut personality descriptor 910 is indicated by a zero value 0 of the fifth binary bit 112.A.5; a lack of a user self-identification with the investor personality descriptor 912 is indicated by a zero value 0 of the sixth binary bit 112.A.6; and a lack of a user self-identification with the vegetarian personality descriptor 914 is indicated by a zero value 0 of the seventh binary bit 112.A.7.

An analysis of the exemplary first user personality data field U.PER.A as illustrated in FIG. 12 indicates that the user identified in the first user identification data field USER.ID.A self-identifies with the gamer descriptor 902 by presenting a one value of the first personality binary bit 112.A.1; and with the vegetarian descriptor 914 by presenting a one value of the seventh personality binary bit 112.A.7. In contrast, the remaining second personality binary bit 112.A.2 through the sixth personality binary bit 112.A.6 of the exemplary first user personality data field U.PER.A present zero values 0and thereby do not indicate a self-identification by the user with the remaining personality descriptors 904-912.

Each of a plurality of ten interests digital bits 112.A.8-112.A.17 of the first user interests data field U.INT.A indicate whether the user identified in the first user identification field USER.ID.A has self-identified as having a particular interests identified by a named interests descriptor 802-820. In the exemplary application of a user account 112.A-112.N of step 424 of the process of FIG. 4, (a.) a zero value 0 indicates that the user associated with a particular user account 112.A-112.N has not self-identified with the interests descriptor 802-820 associated with the zero value 0; and (b.) a one value 1 indicates that the user associated with a particular user account 112.A-112.N has self-identified with the interests descriptor 802-820 associated with the one value 1. For example, the first interests binary bit 112A.8 relates to the first interests descriptor egames 802, and a one value 1 of the first interests binary bit 112A.8 would indicate that the user identified in the first user identification field USER.ID.A has self-identified as having an interest in egames, whereas a zero value 0 of the first interests digital bit 112A.8 would indicate that the user identified in the first user identification field USER.ID.A has not self-identified as having an interest in egames.

Furthermore, a user self-identification with the social media interests descriptor 804 is indicated by a one value 1 of the second interests binary bit 112.A.9; a user self-identification with the entertainment interests descriptor 806 is indicated by a one value 1 of the third interests binary bit 112.A.10; a user self-identification with the sports interests descriptor 808 is indicated by a one value 1 of the fourth interests binary bit 112.A.11; a user self-identification with the gambling interests descriptor 810 is indicated by a one value 1 of the fifth interests binary bit 112.A.12; a user self-identification with the music interests descriptor 812 is indicated by a one value 1 of the sixth interests binary bit 112.A.13; a user self-identification with the travel interests descriptor 814 is indicated by a one value 1 of the seventh interests binary bit 112.A.14; a user self-identification with the fitness interests descriptor 816 is indicated by a one value 1 of the eighth interests binary bit 112.A.15; a user self-identification with the a health interests descriptor 818 is indicated by a one value 1 of the ninth interests binary bit 112.A.16; and a user self-identification with the food interests descriptor 820 is indicated by a one value 1 of the tenth interests binary bit 112.A.17.

Alternatively, a lack of user self-identification with the social media interests descriptor 804 is indicated by a zero value 0 of the second interests binary bit 112.A.9; a lack of user self-identification with the entertainment interests descriptor 806 is indicated by a zero value 0 of the third interests binary bit 112.A.10; a lack of user self-identification with the sports interests descriptor 808 is indicated by a zero value 0 of the fourth interests binary bit 112.A.11; a lack of user self-identification with the gambling interests descriptor 810 is indicated by a zero value 0 of the fifth interests binary bit 112.A.12; a lack of user self-identification with the music interests descriptor 812 is indicated by a zero value 0 of the sixth interests binary bit 112.A.13; a lack of user self-identification with the travel interests descriptor 814 is indicated by a zero value 0 of the seventh interests binary bit 112.A.14; a lack of user self-identification with the fitness interests descriptor 816 is indicated by a zero value 0 of the eighth interests binary bit 112.A.15; a lack of user self-identification with the a health interests descriptor 818 is indicated by a zero value 0 of the ninth interests binary bit 112.A.16; and a lack of user self-identification with the food interests descriptor 820 is indicated by a zero value 0 of the tenth interests binary bit 112.A.17.

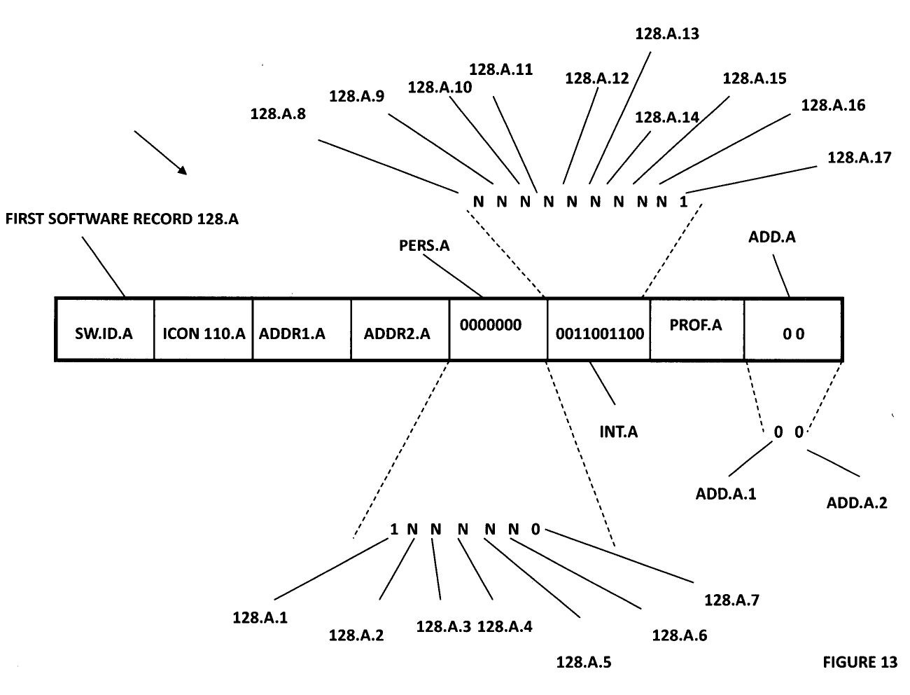

Referring now generally to the Figures and particularly to FIG. 13, FIG. 13 is a schematic diagram illustrating a plurality of software match binary data 128.A.1-128.A.17 stored within the exemplary first personality matching data PERS.A and the first interests matching data field INT.A of the exemplary first software record 128.A. Each of a plurality of seven personality match binary bits 128.A.1-128.A.7 of the first matching personality data field PERS.A indicate whether the first software 130.A is denoted for presentation to a user having self-identified with a particular personality aspect identified by a named personality descriptor 902-914. For example, when a first personality match binary bit 128.A.1 presents a one value, the computer 100 will include the first application icon display data 110.A within the start-up desktop image 108 when the user account 112.A-112.N selected in step 412 or applied in step 424 of the process of FIG. 4 includes a first personality binary bit 112.A presents a one value 1, and will not present the first application icon display data 110.A within the start-up desktop image 108 when the first personality match binary bit 128.A.1 presents a one value and the first personality binary bit 112.A presents a zero value 0 or a null value.

In another aspect of the plurality of software match binary data 128.A.1-128.A.17, a second personality match binary bit 128.A.2 may present a null value N, wherein the process of FIG. 4 in steps 412 and 424 will not consider the value of the second personality bit 112.A.2 of the first account 112.A, wherein neither a zero value 0 nor a one value 1 will neither inhibit the computer 100 from selecting, nor direct the computer 100 to select, the first application icon display data 110.A in the start-up desktop image 108.

The exemplary first software record 128.A includes the seven personality match binary bits 128.A.1-128.A.7 of the first personality data filed PERS.A and a plurality of ten interests match binary bits 128.A.8-128.A.17 of the first interests data field INT.A. The first personality match bit 128.A.1 of the first software record 128.A presents a one value 1; the seventh personality match bit 128.A.7 presents a zero value 0; and the remaining second personality match bit 128.A.2 through the sixth personality match bit 128.A.6 of the first software record 128.A each present null values N. The first interests match binary value 128.A.8 through the ninth interests match binary value 128.A.16 each present a null value N; and the tenth interests match value 128.A.17 presents a one value 1.

When the computer 100 applies the first software record 128.A with any user account 112.A-112.N in an execution of a step 412 or 424, a match will be found whenever the following three states are all found to exist: (1.) the first personality binary bit 112.N.1 presents a one value 1, (2.) the seventh personality binary bit 112.N.7 presents a zero value 0, and (3.) the tenth interests binary bit 112.N.17 presents a one value 1. It is understood that the values of the remaining user account binary bits 112.N.3-112.N.16 will be irrelevant to the determination of a match by the computer 100. It is understood that a determination of a match by the computer 100 between a selected user account 112.A-112.N and any software record 128.A-128.Z directs the computer 100 to render an icon data 110.A-110.Z associated with the matching software record 128.A-128.Z in the start-up display image 108.

It is further understood that matches may be arrived at by the computer by comparing profile data of a user profile U.PROF.A-U.PROF.N of a user account 112.A-112.N with a software account profile data PROF.A-PROF.Z of the software records 128.A-128.Z.

Each software record 128.A-128.Z may further comprise a first additional bit ADD.A.1 and a second additional bit ADD.A.2, wherein when the first additional bit ADD.A.1 is set to a one value, 1, the computer 100 is directed to always render an icon data 110.A-110.Z in the start-up desktop image 108 regardless of the application or selection of a user account 112.A-112.N. The computer 100 may further be inhibiting a deletion form the computer 100 of software program 130.A-130.Z associated with a software record 128.A-128.Z when the second additional bit ADD.2 of the associated software record 128.A-128.Z presents a one value 1. It is understood that in certain variations of the method of the present invention, the zero value 0 or the null value N may be used in place of the one value 1 and with the same effect, in the first additional bit ADD.A.1 and/or the second additional bit ADD.A.2.

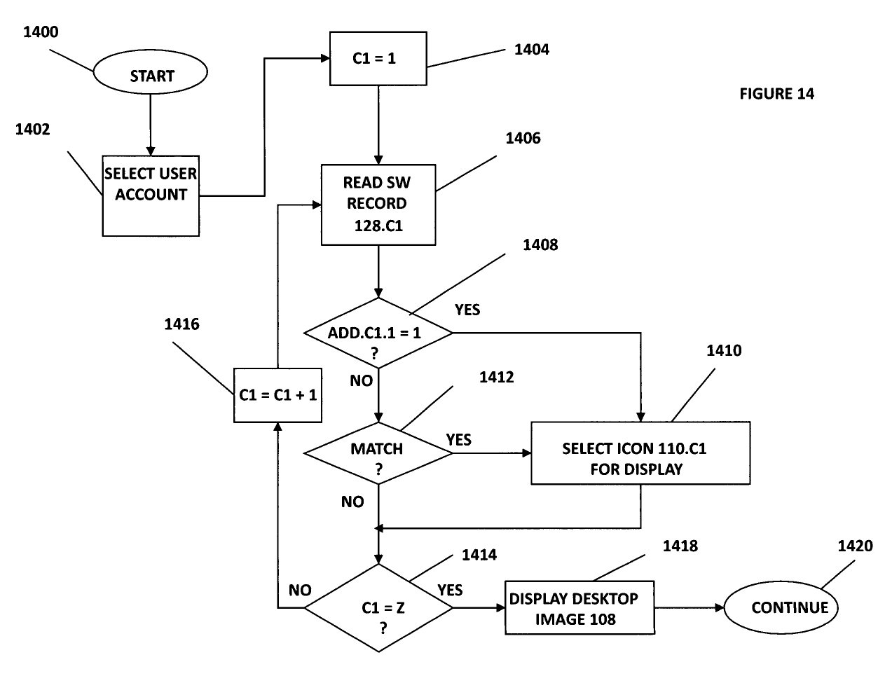

Referring now generally to the Figures and particularly to FIG. 14, FIG. 14 is a flowchart of a computer implemented process wherein an even additional aspect of the method of the present invention is practiced. The computer 100 as directed by a user selects a user account 112.A-112.N in step 1402 and then sets a first counter C1 to a one value 1 in step 1404. The computer 100 selects the instant software record 128.C1 from the software registry 126 in step 1406 and reads the first additional bit ADD.C1.1 of the instant software record 128.C1 to determine whether the value of the instant first additional bit ADD.C1.1 is set to direct the computer 110 to display the icon 110.C1 of the instant software record 128.C1 even without a match condition existing between the user account 1112.A-112.N and the instant software record 128.C1. When the additional bit ADD.C1.1 read in step 1408 is equal to a value indicating an instruction to automatically render the icon 110.C1, e.g., a one value 1 in the process of FIG. 14, the computer 100 proceeds from step 1308 to step 1410 and selects the icon 110.C of the instant software record 128.C1 for rendering within the start-up desktop image 108.

When the instant additional bit ADD.C1.1 read in step 1408 is not equal to value indicating an instruction to automatically render the icon 110.C1, e.g., a zero value 0 in the process of FIG. 14, the computer 100 proceeds to step 1412 and then compares values of the instant software record 128.C1 with the user account selected in step 1402. When the computer 100 determines in step 1412 that a match exists between the instant software record 128.C1 with the user account 112.A-112.N selected in step 1402, the computer 100 proceeds from step 1412 to step 1410 and selects the icon 110.C1 of the instant software record 128.C1 for rendering in the start-up desktop image 108. The computer 100 proceeds from step 1410 or 1412 to step 1414 and to determine whether the instant software record 128.C1 is the last software record 128.Z in the software registry 126.

When the computer 100 determines in step 1414 that the instant software record 128.C1 is not the last software record 128.Z in the software registry 126, the computer 100 proceeds to step 1416 to increment the value of the first counter C1 and the from step 1416 to step 1406 and to read a succeeding software record 128.C1 from the software registry 126.

When the computer 100 determines in step 1414 that the instant software record 128.C1 is the last software record 128.Z in the software registry 126, the computer 100 proceeds to step 1418 and to render the desktop image 108 on the display screen 104.

When the computer 100 determines in step 1414 that the instant software record 128.C1 is the last software record 128.Z in the software registry 126, the computer 100 proceeds to step 1418 and to render the desktop image 108 on the display screen 104.

In step 1420 the computer 100 informs the server 120 of the software programs 130.A-130.Z for which associated icon data 110.A-110.Z that is rendered in step 1418. The computer 100 further informs the server 120 of the software programs 130.A-130.Z that are selected for launch from the desktop image 108 in step 1422. The computer 100 proceeds from step 1422 and to step 1422 and to perform additional computational operations.

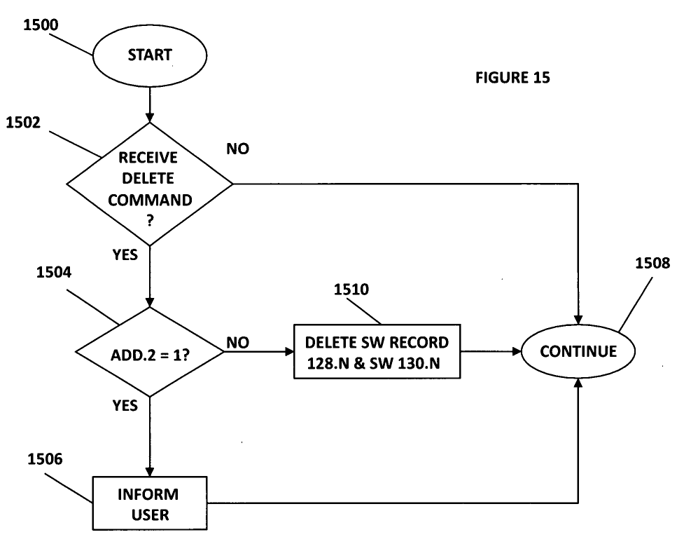

Referring now generally to the Figures and particularly to FIG. 15, FIG. 15 is a flowchart of a computer implemented process wherein a yet other additional aspect of the method of the present invention is practiced. In step 1502 the computer 100 determines a command to delete a specified software program 130.A-130.Z, has been received by the computer 100. When the computer 100 detects in step 1502 a receipt of a command to delete a specific software program 130.A-130.Z, or “instant software program” 130.N., the computer 100 proceeds on to step 1504.

The computer 100 reads the second additional bit ADD.A.2-ADD.N.2 of the software record 128.N associated with the instant software program 130.N in step 1504. When the second additional bit ADD.A.2-ADD.N.2 indicates that the computer 100 is prohibited from deleting the instant software program 130.N, the computer 100 proceeds from step 1504 to step 1506 and to inform the user by means of a message sent to the display screen 104 that the computer 100 is not authorized to delete the instant software program 130.N. The computer 100 proceeds from step 1506 and to step 1508 and to perform additional computational operations.

When the second additional bit ADD.A.2-ADD.N.2 indicates that the computer 100 is not prohibited from deleting the instant software program 130.N, the computer 100 proceeds from step 1504 to step 1510 to delete the instant software program 130.N and the associated software record 128.N from the software registry 126. The computer 100 proceeds from step 1510 and to step 1508 and to perform additional computational operations.

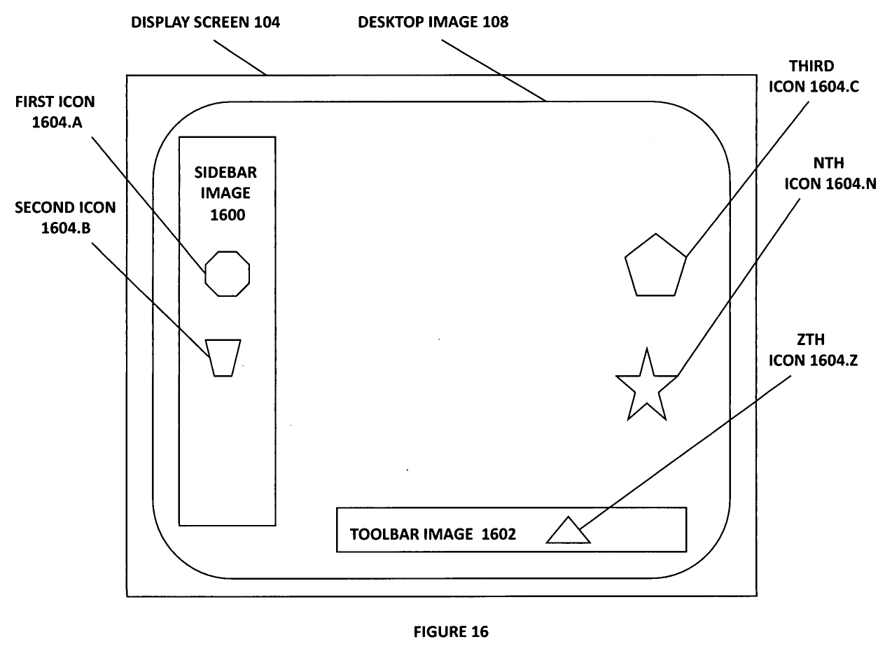

Referring now generally to the Figures and particularly to FIG. 16, FIG. 16 is an illustration of the start-up desktop image 108 as rendered in part from the plurality of application icon display data 110.A-110.Z of the software records 128.A-128.Z of the software registry 126. A sidebar image 1600 and a toolbar image 1602 are also rendered by the computer 100 and within the desktop image 108 as visually presented by the display screen 104. A plurality of software program launch icons 1604.A-1604.Z are further rendered within the desktop 108 by the computer 100. Each of the plurality of the software program icons 1604.A-1604.Z are rendered from a corresponding icon display data 110.A-110.Z. For example, the first software program launch icon 1604.A is rendered from the first icon display data 110.A of the first software record 128.A. For another example, the second software program icon 1604.B is rendered from the second icon display data 110.B of the second software record 128.B. In addition, the third software program launch icon 1604.C is rendered from the third icon display data 110.C of the third software record 128.C. Furthermore, the Nth software program launch icon 1604.N is rendered from the Nth icon display data 110.N of the Nth software record 128.N, and the last software program launch icon 1604.Z is rendered from the last icon display data 110.Z of the last software record 128.Z.

A selection of a software program launch icon 1604.A-1604.Z may be affected by the user by manipulation of the computer mouse, whereupon a software program 130.A-130.Z associated with a selected launch icon 1604.A-1604.Z. In one example, when the network 122 comprises the Internet, a user selection of the first launch icon 1604.A directs the computer 100 to run the first software program 130.A wherein the computer 100 may access a web service of the network 122. In one example, when the network 122 comprises an electronics communications network, a user selection of the second launch icon 1604.B directs the computer 100 to run the first software program 130.A wherein the computer 100 initiates a communications session with the server 120 via the network 122.

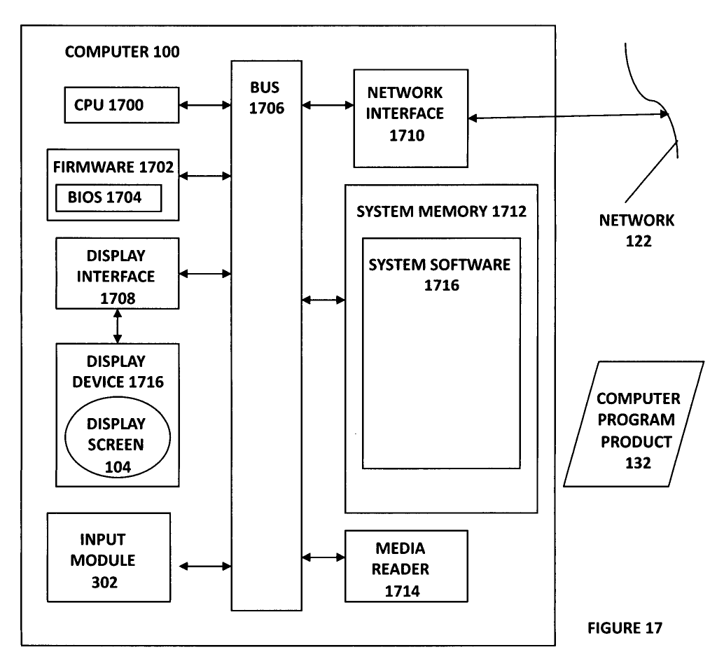

Referring now generally to the Figures and particularly to FIG. 17, FIG. 17 is a schematic diagram of the computer 100. The computer 100 includes a central processing unit 1700, or “CPU” 1700 and a firmware 1702. The firmware 1702 further includes a set of software-encoded instructions comprising a basic input output system 1704, or “BIOS” 1704, used to boot-up the computer 100. A communications bus 1706 bi-directionally communicatively couples the CPU 1700, the firmware 1702, a display interface 1708, the input module 302, a network interface 1710, a system memory 1712, and a media reader 1714. The display interface 1708 bi-directionally communicatively couples a display device 1716 comprising the display screen 104 with the communications bus 1706. The network interface 1710 bi-directionally communicatively couples the electronics communications bus 1706 and the electronics communications network 122.

The system memory 1712 is a random only access memory wherein a system software 1716 is maintained and optionally edited or modified by deletion, addition or updating of software encoded instructions.

The media reader 1714 is configured to read, and optionally write, machine readable, computer executable software encoded instructions form the computer program product 132. The media writer/reader 1714 and the associated computer program product 132 are selected and configure to provide non-volatile storage for the computer 100. Although the description of computer-readable media 30 contained herein refers to a mass storage device, such as a hard disk or CD-ROM drive, it should be appreciated by those skilled in the art that computer-readable media can be any available media that can be accessed by the computer 100.

By way of example, and not limitation, computer-readable media 30 may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

The computer program product 132 may comprise machine-readable instructions which when executed by the computer 100 to cause the computer 100 to perform one or more steps as described in the Figures and enabled by the present disclosure.

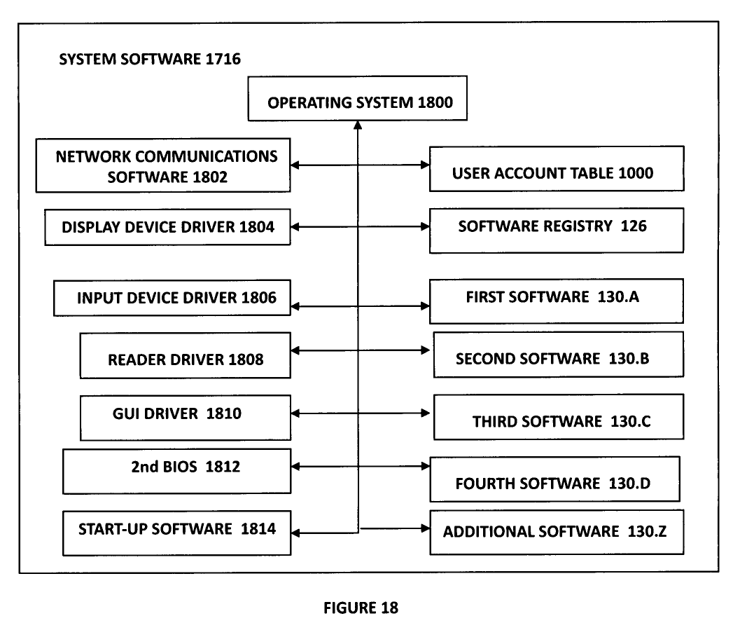

Referring now generally to the Figures and particularly to FIG. 18, FIG. 18 is a schematic diagram of the system software 1716 of the computer 100. An operating system 1800 that acts as a control layer between the hardware elements of the computer 100 and the software of the computer 100. A network communications software 1802 enables the network interface 1710 to bi-directionally couple the electronic communications network 122 with communications bus 1706 and the CPU 1700. A display device driver 1804 enables the CPU 1700 to direct the state of the display screen 104 to include the rendering of the start-up desktop image 108. An input driver 1806 enables the CPU 1700 to accept, execute and interpret commands, instructions, data and selections from the input module 302. A reader driver 1808 enables the CPU 1700 to accept, execute and interpret software encoded programs, commands, instructions, data and selections from the computer program product 132.

A graphical user interface driver 1810, or “GUI” 1810, enables the computer 100 to visually render data, e.g., to render the start-up desktop image 108. An optional 2nd BIOS element 1812 that may affect the execution of the basic input output system 1704 that. A start-up system software 1814 enables the computer to execute or perform one or more aspects of the processes of FIGS. 1, 2, 4, 6, 14 and 15.

The system software 176 further includes the user account table 1000, the software registry 126, and the plurality of software applications 130.A-130.Z

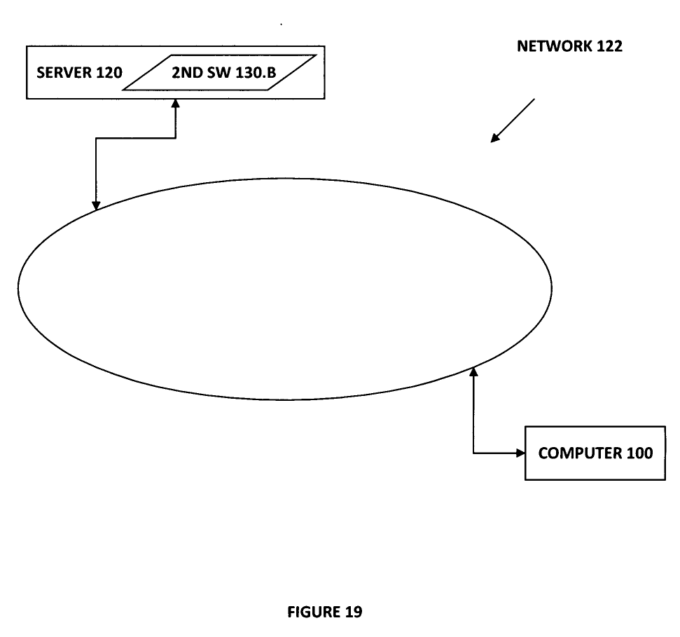

Referring now generally to the Figures and particularly to FIG. 19, FIG. 19 is a schematic diagram of the electronics communications network 122. The electronics communications network 122 may be or comprise the Internet, a computer network, a telephony network, a wireless communications network and/or a wireless telephone network. The server 120 may include one or more applications software 130.A-130.Z that may be downloaded via the network 122 to the computer 100.

The computer 100 may be or comprise an electronic computer system, an information appliance configured for wireless Internet-enabled communication, a television set-top box, and/or a wireless communications capable communications device, such as (a.) a VAIO FS8900 (TM) notebook computer marketed by Sony Corporation of America, of New York City, N.Y., (b.) a wireless communications enabled SUN SPARCSERVER (TM) computer workstation marketed by Sun Microsystems of Santa Clara, Calif. running LINUX (TM) or UNIX (TM) operating system; (c.) a wireless communications enabled personal computer configured for running WINDOWS XP (TM) or VISTA (TM) operating system marketed by Microsoft Corporation of Redmond, Wash.; (d.) a PowerBook G4 (TM) personal computer as marketed by Apple Computer of Cupertino, Calif.; (e.) an iPhone (TM) cellular telephone as marketed by Apple Computer of Cupertino, Calif.; or (f.) a personal digital assistant enabled for wireless communications.

The server 120 may be or comprise an electronic computer system configured for bi-directional communications with the network 122, such as (a.) a SUN SPARCSERVER (TM) computer workstation marketed by Sun Microsystems of Santa Clara, Calif. running LINUX (TM) or UNIX (TM) operating system; (b.) a server or personal computer configured for running WINDOWS XP (TM) or VISTA (TM) operating system marketed by Microsoft Corporation of Redmond, Wash.; (c.) a PowerBook G4 (TM) personal computer as marketed by Apple Computer of Cupertino, Calif.; (d.) an information appliance configured for Internet-enabled communication; and (e.) a wireless communications-enabled communications device.

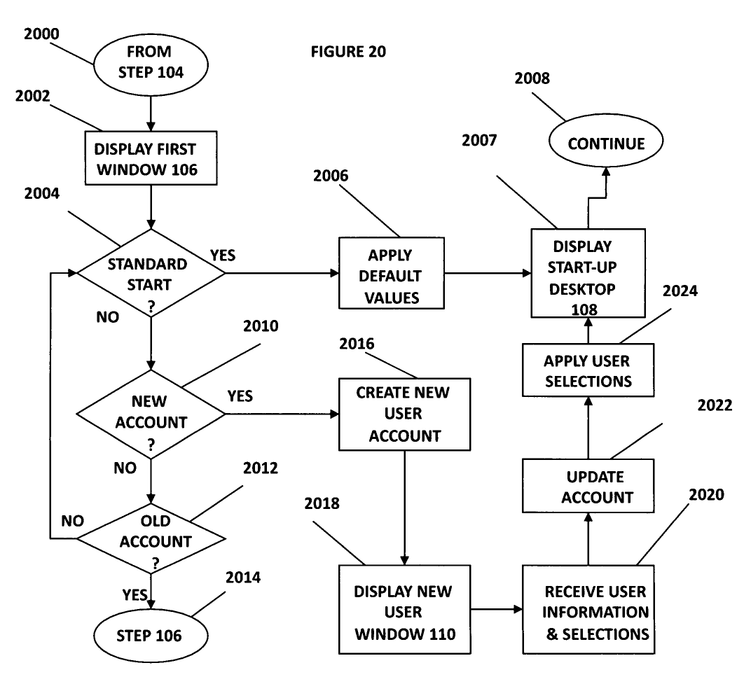

Referring now generally to the Figures and particularly to FIG. 20, FIG. 20 is a flowchart of a computer implemented process wherein a still alternate aspect of the method of the present invention is practiced when the computer 100 is offline and/or not in communication with the network 122 and/or the remote server 120. The computer 100 proceeds from step 104 of the process of FIG. 1 to display the first window 106 in the display screen 102 in step 2002. The computer determines in step 2004 whether the user has chosen the standard start option 308 by means of the input device 302. In one exemplary configuration of the computer 100, the input module 302 comprises a computer mouse 312 and the user positions the cursor 304 over the displayed text of the standard start option 310 as displayed on the display screen 104, and the user additionally engages a selection button 314 of the computer mouse 312. The engagement of the selection button 314 of the computer mouse 312 thereby issues a command to the computer 100 to proceed from step 2004 to step 2006 and to apply default values to the boot-up process initiated in step 102 of the process of FIG. 1, wherein the default values are stored in a memory element 132, 1702, 1712 comprised within or accessible to the computer 100. The computer 100 proceeds from step 2006 to step 2007 and to display the start-up desktop image 108 on the display screen 102. The computer 100 then proceeds from step 2007 to step 2008 to perform additional computational processes.

Alternatively, the computer determines in step 2010 whether the user has chosen the new account start 310 by means of the input device 302. When a selection of the standard start 308 is not determined in step 2004, nor a selection of the new account start 310 is determined in step 2010, the computer 100 proceeds on to step 2012. Computer 100 determines in step 2012 whether the user has selected an established, I.e. an “old account”, from the first display window 106. When the computer 100 determines in step 2012 that the user has selected an established user account from the display first window 106, the computer 106 proceeds from step 2012 to step 2014 and to execute step 106. When the computer 100 determines in step 2012 that the user has not selected an established user account from the display first window 106, the computer 100 proceeds from step 2012 to step 2004.

When the computer determines in step 2010 whether the user has chosen the new account start 310 by means of the input device 302, the computer 100 proceeds to step 2016 and to create a new user account 112.A-112.N, and to display the new user window 112 in step 2018 via the display screen 104. The computer 100 receives information and menu item selections from the computer in step 2020, and in step 2022 the computer 100 updates and populates the user account 112.A-112.N created in step 2016 with the selections and information received the user. The computer 100 applies the instant user account 112.A-112.N in step 2024 in the boot-up process initiated in step 102, wherein the information and menu item selections received in step 2020 are applied. The computer 100 proceeds from step 2024 to step 2007 and to display a start-up desktop image 108 on the display screen 102. The computer 100 then proceeds from step 2007 to step 2008 to perform additional computational processes.

According to the method of FIG. 20, user selection and access to modify the software registry 126 and the user account table 1000 are enabled while the computer 100 is offline and not in communication with the network 122 and/or the remote server 120. Further according to the method of FIG. 20, user selection and access to modify and/or run the software applications 130.A-130.Z are enabled while the computer 100 is offline and/or not in communication with the network 122 and/or the remote server 120. Even further according to the method of FIG. 20, one or several of the aspects of the methods of FIGS. 1 through 16 are enabled while the computer 100 is offline and/or not in communication with the network 122 and/or the remote server 120. Alternately or additionally, according to the method of FIG. 2, one, several or all of the aspects of the methods of FIGS. 1 through 16 may be instantiated or performed by the computer 100 and without informational input or direction from the network 122 and/or the remote server 120.

According to other additional aspects of the method of the present invention, the system software 1712 and the computer 100 enables a user to direct the computer 100 while the computer 100 is offline and not in communication with the network 122 and/or the remote server 120, to (a.) modify the software registry 126 and/or the user account table 1000; and/or to modify and/or run one or more software applications 130.A-130.Z.

The terms of “condition” and “term” are defined as synonyms within their definition as applied within the present disclosure. The terms of “additional condition” and “additional term” are defined as synonyms within their definition as applied within the present disclosure. The terms of “conditions” and “terms” are defined as synonyms within their definition as applied within the present disclosure. The terms of “additional conditions” and “additional terms” are defined as synonyms within their definition as applied within the present disclosure.

The foregoing disclosures and statements are illustrative only of the present invention, and are not intended to limit or define the scope of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. A computer-implemented method comprising:
initiating a boot-up of a computer:
requesting information from a user;
receiving information from the user;
selecting at least one launch icon for display by the computer at least partly on the basis of the received information;
completing the boot-up process; and
displaying the at least one launch icon within a start-up image.

2. The method of claim 1, wherein the boot-up process is within an out-of-the-box experience of the user.

3. The method of claim 1, wherein displaying the at least one launch icon is accomplished within the boot process.

4. The method of claim 1, further comprising downloading at least one software encoded instruction associated with the at least one launch icon via an electronic communications network.

5. The method of claim 1, wherein the at least one software program is deleted form the computer at least partly on the basis of the received information.

6. The method of claim 1, further comprising transmitting at least a datum of the received information via an electronics communication network to a server.

7. The method of claim 1, further comprising informing a server via an electronics communication network of the selection of the at least one launch icon.

8. The method of claim 1, further comprising receiving a launch command by the computer; and informing a server via an electronics communication network of the launch command receipt.

9. The method of claim 1, wherein the information comprises an indication by the user of an interest selected from the group of interests essentially comprising electronic games, gambling, food, travel, technology, music, news, financial news, fashion, sports, health, medical, legal, professional and software.

10. The method of claim 1, wherein the information comprises an indication by the user of a user type selected from the group of user types essentially comprising professional, small business manager, health care worker, technologist, child, high school student, University student, electronic gamer, shopper, retiree, senior and health care worker.

11 The method of claim 1, further comprising:
initiating a bi-directional communications session with a server via an electronic communications network after the at least one launch icon is displayed; and
providing additional software encoded instructions to the computer form the server.

12. The method of claim 11, wherein the application of the additional software encoded instructions by the computer occurs within a succeeding boot-up of the computer.

13. The method of claim 11, wherein the additional software encoded instructions direct the computer to offer access to an additional computational functionality.

14. The method of claim 13, wherein the additional computational functionality is a web service.

15. The method of claim 1, further comprising receipt by the computer of a launch command, wherein the launch command is associated with the at least one launch icon.

16. The method of claim 15, further comprising the computer initiating a communication session with a server via an electronics communications network in response to receipt by the computer of the launch command.

17. An information technology system comprising:
one or more processors;
at least one network interface configured to bi-directionally communicatively couple the information technology system with an electronics communications network;
a memory accessible by the at least one of the one or more processors;
a display module configured to visually display information received from the memory or the at least one network interface;
a process operated by the one or more processors to manage software program selection, the process being effective to:
initiate a boot-up of the information technology system:
request information from a user;
receive information from the user;
select at least one launch icon for display by the information technology system at least partly on the basis of the received information;
complete the boot-up process; and
display the at least one launch icon by means of the display module.

18. The information technology system of claim 17, wherein the at least one network interface configured to bi-directionally communicatively couple the information technology system with the Internet.

19. The information technology system of claim 17, wherein the process is further effective to delete at least one software encoded instruction at least partly on the basis of the received information.

20. A computer program product comprising:
a computer operable medium having computer readable code, the computer readable code being effective to:
initiate a boot-up of the information technology system:
request information from a user;
receive information from the user;
select at least one launch icon for display by the information technology system at least partly on the basis of the received information;
complete the boot-up process; and
display the at least one launch icon by means of the display module.
